(19) United States
(12) Patent Application Publication
(10) Pub. No.: US 2014/0124633 A1
(43) Pub. Date: May 8, 2014

(54) DEVICE FOR FIXING AN ELECTRONIC BOX IN THE WHEEL OF A VEHICLE AND METHOD FOR MANUFACTURING AN ADAPTED TYRE

(71) Applicant: Thibault BENARD DE VEDELLY, Muret (FR)

(72) Inventor: Thibault BENARD DE VEDELLY, Muret (FR)

(21) Appl. No.: 13/848,368

(22) Filed: Mar. 21, 2013

(30) Foreign Application Priority Data
Mar. 23, 2012 (FR) 1252655

(51) Int. Cl. B60C 23/04

(52) U.S. Cl. CPC B60C 23/0491
USPC 248/205.1; 156/110.1

(57) ABSTRACT

A device for fixing a measurement box (B) on the internal wall (100) of a tire (P), comprises at least one bracing element interposed between the box (B) and the internal wall so as to create a space (E) between the box (B) and the internal wall (100).

The invention also concerns a method of manufacturing a tire (P), remarkable in that it consists of moulding at least one projection (110, 120) on the internal wall of the tire (P).

Applications: measurement in wheels

### FIELD OF APPLICATION OF THE INVENTION

The present invention relates to the field of the detection of parameters in wheels of a vehicle and particular to the adaptations for fixing a detection box inside a wheel in the best way.

### DESCRIPTION OF THE PRIOR ART

There exists a plurality of solutions for fixing electronic boxes for measuring parameters such as the temperature and pressure in a tire on a wheel.

Thus, for example, one solution consists of fixing these boxes by means of the valve hole in the rim as described in the document EP 1 647 422.

Such a solution can be considered to be tedious and requires a specific solution that depends on the number and diversity of the profiles of the rims to be equipped.

Another solution consists of using a circumferential fixing by means for example of a cable as described in the document EP 2 392 480. This solution remains expensive to produce and some very narrow rim profiles do not allow such installation.

Another drawback of these two groups of solutions is proposing an arrangement of the box that constitutes an obstacle to the sides of the tire during operations of installation on the rim or removal.

One solution for solving the above-mentioned drawback would consist of fixing the box to the internal walls of the tire. Such a solution does nevertheless have several drawbacks, including the following:
the proximity of the box to the tire tread subjects it to the same impacts, temperature changes and deformations (such as folding) as those undergone by the tire on a wide spectrum of frequencies,
centrifugal force tends to hold the sensor in position but also to orient towards the outside any material contained in the tire then tending to obstruct the orifices of the sensor or sensors.

### DESCRIPTION OF PREFERRED EMBODIMENTS OF THE INVENTION

Starting from this prior art, the applicant carried out research aimed at proposing a fixing solution solving the drawbacks of the prior art. This research resulted in the design and production of a particularly judicious and inexpensive fixing device.

According to a preferred embodiment of the invention, this device for fixing a box for making measurements on the internal wall of a tire is remarkable in that it comprises at least one bracing element interposed between the box and the internal wall so as to create a space between the box and the internal wall.

This feature is particularly advantageous in that it proposes a fixing for the box that is independent of the rim. It also proposes a fixing to the internal wall of the tire thus allowing the operations of mounting the tire on the rim and removing it therefrom without risk of pulling away of the box.

In addition, it proposes a suspended fixing, that is to say a fixing to the internal wall but at a distance from the latter in order to prevent the majority of the deformations (folds), impacts and heating to which it is subjected, being transferred to the box. The fixing device of a preferred embodiment of the invention thus solves the drawbacks of the devices of the prior art.

According to another particularly advantageous feature, this fixing device is remarkable in that it comprises at least one projection constituting the bracing element, one end of which is fixed to the internal wall and projecting towards the inside of the tire, the box being fixed to the projection at a certain distance from the internal wall so that a space is created between the box and the internal wall from which the projection arises.

According to another particularly advantageous feature, the projection is preformed from a support and holding surface for the box, disposed at a certain distance from the internal wall so that a space is created between the box and the internal wall where the projection arises. Thus it is the projection that is preformed in order to serve as a positioning stop for the box, positioning creating the space between the box and the wall of the tire.

Other features relating to the preformation of the projections have been designed, thus for example:
the projection is preformed from a change in cross section in order to create a support surface for the box,
the projection comprises two changes in cross section creating two shoulders between which the box is disposed in order to serve firstly as a support surface and secondly as a holding surface,
the projection is produced from an elastic material and is preformed so that traction on the free end thereof provides narrowing of the holding surface to enable the box to be installed.

According to another particularly judicious feature, the projection arises from the internal face of the tire tread. Thus the centrifugal force applied to the box will tend, when the wheel rotates, to hold the box in position on the projection and in particular on the support surface preformed in the latter, without weakening its fixing. Through the presence of the bracing element of a preferred embodiment of the invention, the fixing to the internal face of the tread is made possible.

The arrangement of the box fixed by means of the bracing element to the internal face of the tread without contact of the box with the face also makes it possible to orient it so that the measuring orifice or orifices giving access to the sensor are oriented towards the internal tire tread face. Such an arrangement is particularly advantageous in that it guarantees the non-obstruction of the orifices because the centrifugal force ensures outward projection of any element present in the tire. In order to guarantee this opening, the sensor is equipped with a cap preventing the obstruction of its measuring orifice when the encapsulating material is poured in the box. Such arrangements have the great advantage of avoiding the presence of a closure and protection cover for the box.

According to another preferred feature, the device comprises two projections, which means that the box is preformed with two fixing orifices adopting substantially the same separation, in order to come to be engaged on the two projections. Naturally the number of projections is not limitative, the principle being to offer a support surface formed by one or more support points disposed at a distance from the internal wall and adapted to the geometry of the box. Likewise, their arrangement in the tire is not limitative.

According to another particularly advantageous feature, the projection is associated with the top face of a flat piece the bottom face of which is adhesively bonded to the internal wall. This flat piece may also support several projections.

According to another feature, the projection is produced from an elastic material and, according to a preferred embodiment, from the same elastic material as the tire. Such a choice of material makes it possible not only to easily envisage fixing of the projections by adhesive bonding to the internal wall of the tire but also to propose a method of manufacturing the tire in which the projection or projections are obtained by moulding the tire. Thus another subject matter of a preferred embodiment of the invention lies in the method of manufacturing a tire adapted to the fixing device, that is to say where the tire comprises at least one projection constituting a bracing element one end of which is fixed to the internal wall of the tire and projects towards the inside of the tire, a measuring box being fixed to the projection at a certain distance from the internal wall so that a space is created between the box and the internal wall from where the projection arises. This method is remarkable in that it consists of moulding the at least one projection constituting the bracing element in the internal wall of the tire.

According to a preferred embodiment, this method consists of moulding two projections.

One or more projections issuing from the box can constitute the bracing element. Thus, according to another feature, the box is preformed from at least one projection constituting the bracing element coming to be fixed to the internal wall of the tire while creating a space between the box and the internal wall.

The fundamental concepts of a preferred embodiment of the invention having just been disclosed above in their most elementary form, other details and features will emerge more clearly from a reading of the following description and with regard to the accompanying drawings, giving by way of non-limitative example an embodiment of a device according to the invention.

### BRIEF DESCRIPTION OF THE DRAWINGS

FIG. 1 is a schematic drawing of a side view in section of a tire accepting an embodiment of a device according to the invention;

FIG. 2 is a schematic drawing of a front view in section along the cutting plane II-II defined in FIG. 1 of the tire of FIG. 1;

FIG. 3 is a schematic drawing of a front view in detailed section of the device alone;

FIG. 4 is a schematic drawing of a front view in detailed section of another embodiment of the device alone;

FIG. 5 is a schematic drawing of a front view in detailed section of another embodiment of the device alone;

FIG. 6 is a schematic drawing of a side view in section along the cutting plane VI-VI defined in FIG. 7 of a tire accepting another embodiment of a device according to the invention;

FIG. 7 is a schematic drawing of a front view in section of the tire of FIG. 6.

### DETAILED DESCRIPTION OF PREFERRED EMBODIMENTS

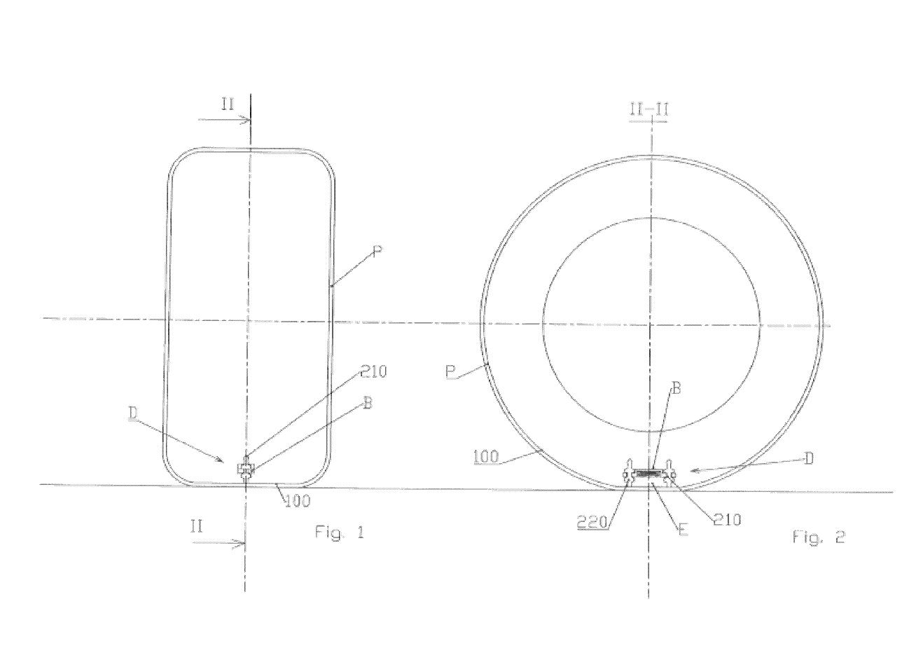

As illustrated in the drawing of FIGS. 1 and 2, the fixing device referenced D provides the securing of a measuring box referenced B to the internal face 100 of the tread of a tire P at its vertical symmetry plane.

This device D comprises two projections 210 and 220 projecting from the internal face 100 and on which the box B comes to be fixed in order to adopt a suspended position between the centre of the tire P and the internal face 100. This is because, as illustrated, a space E is created between the box B and the internal face 100.

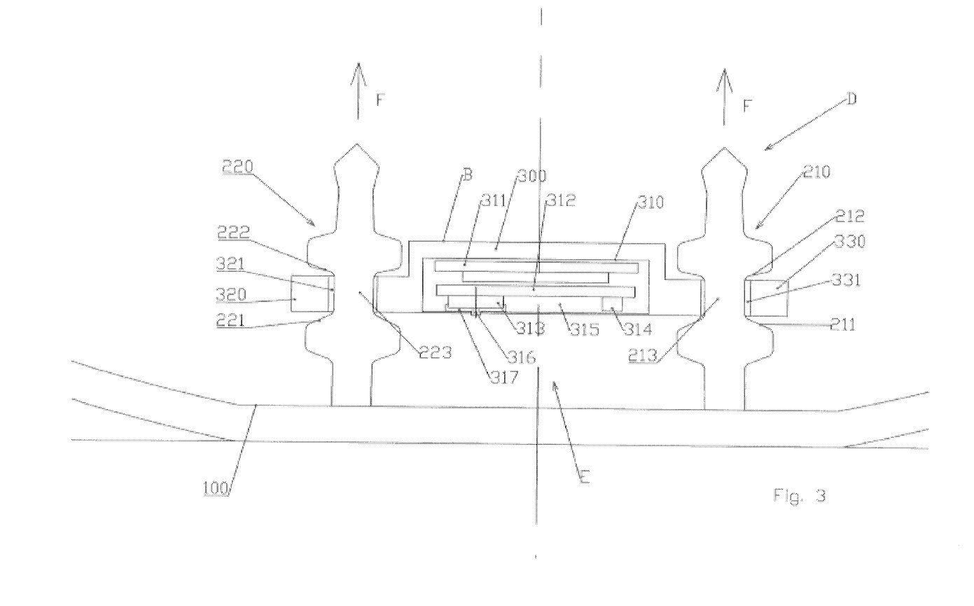

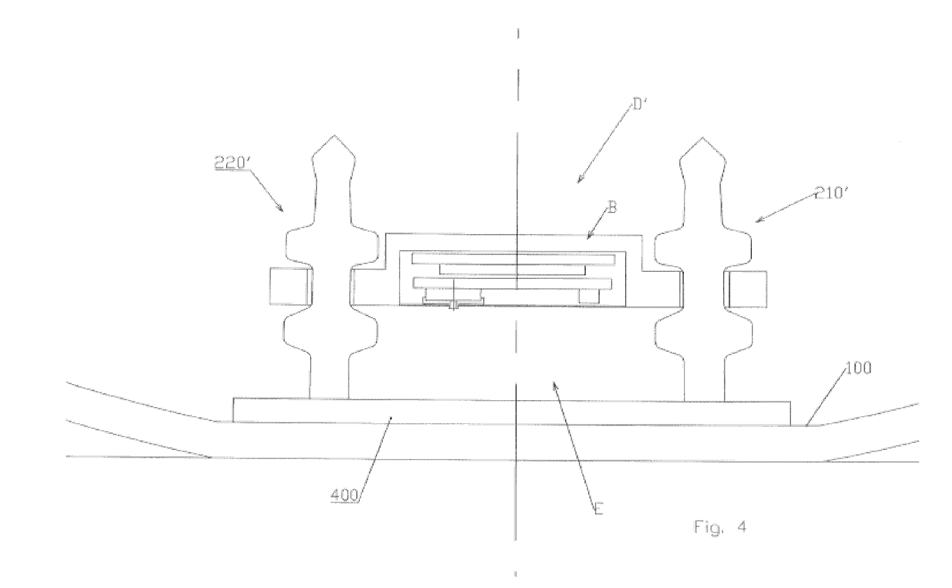

As illustrated in the drawing in FIG. 3, the projections 210 and 220 are cylindrical, identical and preformed from several changes in cross section for creating a support surface 211 and 221 for the box B at a distance from the internal face 100 as well as a holding surface 212 and 222, on either side of a projection portion 213 and 223 with a cross section less than those of the portions forming support and/or holding surfaces. These projections are oriented along a radius but come to be positioned perpendicular to the ground when the tire P is flattened as illustrated.

The box B comprises a shell 300 forming a concave accepting volume 310 open towards the internal face 100. On either side of this accepting volume, the shell 300 is equipped with two projections 320 and 330 forming fixing lugs pierced respectively with orifices 321 and 331, the separation of which corresponds substantially to the separation of the projections that come to be engaged therein. It is these orifices and the surfaces in which they are formed that constitute the functional surfaces with which the support 211, 221 and holding 212, 222 surfaces preformed in the projections cooperate.

This is because the projections 210 and 220 fit in the orifices 331 and 321 so that the lugs 320 and 330 are positioned between the support surfaces 221 and 211 and the holding surfaces 222 and 212.

The centrifugal force applying to the box B when the wheel rotates will tend to hold it against the support surfaces 211 and 221, thus guaranteeing the holding in position thereof.

In order to allow the fitting of the box 300 level with the portions 213 and 223 of the projections 210 and 220, the latter, which are advantageously made from an elastic material, are preformed so that manual traction towards the centre of the tire along the arrow F on their free end provides a narrowing of the protrusion constituting the holding surface 212 and 222, thus enabling the protrusion to pass through the orifices 331 and 321 for fixing the box B and opening up thereof once the traction has ended to implement their holding function.

Whereas the embodiment illustrated by the drawing in FIG. 2 shows two projections, one end of which is directly associated for adhesive bonding with the internal wall 100, another embodiment is envisaged and illustrated by the drawing in FIG. 4.

In this FIG. 4, the device D′ repeats the two projections 210′ and 220′ issuing from the top face of a flat piece 400, the internal face of which is adhesively bonded to the internal wall 100. Such a configuration facilitates the adhesion to the internal wall 100 by increasing the contact surface without deviating from the principles of the invention, which consists of keeping the box in suspension with respect to the internal face 100. According to an embodiment that is not illustrated, at least part of the bottom end of the projection is introduced into the thickness of the tire.

A particularly advantageous feature of a preferred embodiment of the invention that makes it possible to use this suspended arrangement creating a space E between the box B and the internal face 100, lies in the orientation of the box and its content with respect to the internal face and arrangements relating to the content.

As illustrated in the drawings of FIGS. 3 and 4, the accepting volume 310 of the shell 300 of the box B contains a battery 311, a printed circuit 312, a pressure sensor 313 and an RF antenna 314, all the components being embedded in an encapsulating material 315. This accepting volume 310 is open on the face of the box oriented towards the internal face 100 and the pressure sensor 313 comprises a measurement orifice 316 opening onto the space E. As explained above, such an arrangement guarantees that no material obstructs the orifice 316 because the centrifugal force will tend to drag outwards any material contained in the wheel, thus preventing any obturation.

So that such obturation does not occur during the manufacturing of the box in the operation of encapsulation by the material 315, the pressure sensor 313 is advantageously equipped with a cap 317 preventing obstruction of its measurement orifice 316 when the encapsulating material 315 is poured in the box.

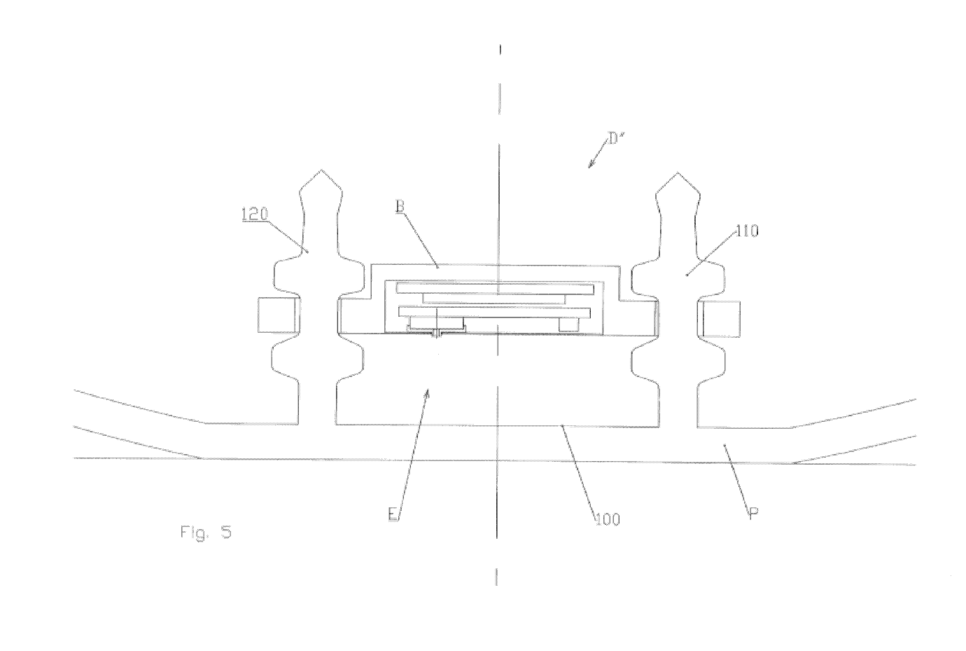

FIG. 5 illustrates an embodiment where the projections 110 and 120 of the device D″ issue directly from the moulding of the tire in accordance with the manufacturing method of a preferred embodiment of the invention.

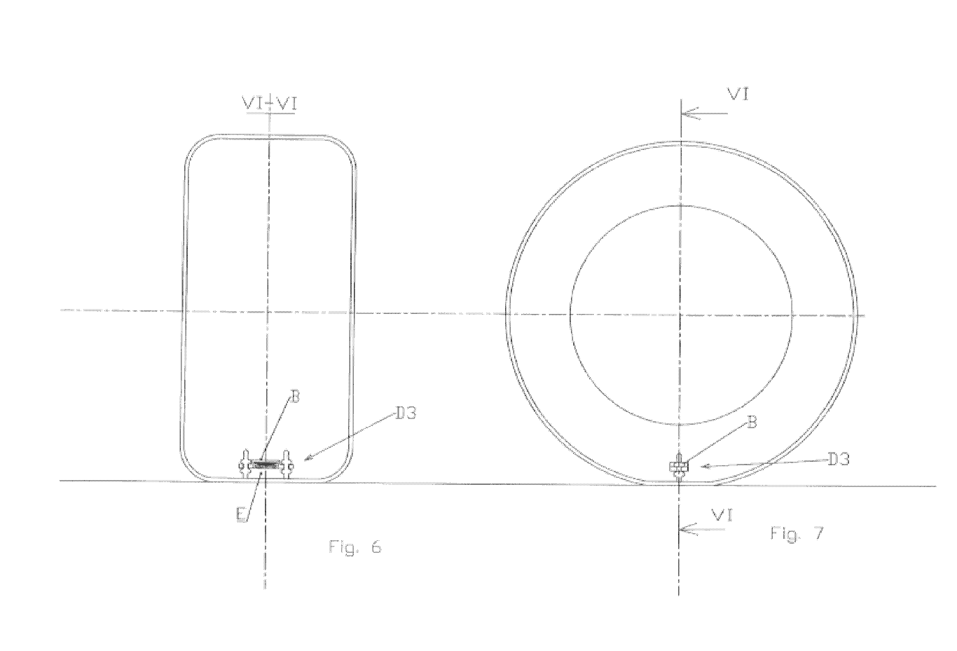

FIGS. 6 and 7 illustrate another embodiment of a device D3 where the projections are disposed in a plane perpendicular to the one illustrated by the drawings in FIGS. 1 to 5.

It will be understood that the device that has just been described and depicted above has been described and depicted with a view to disclosure rather than a limitation. Naturally various arrangements, modifications and improvements can be made to the above example without for all that departing from the scope of the invention.

1. A device for fixing a measurement box (B) to the internal wall (100) of a tire (P),
characterized by the fact that it comprises at least one bracing element interposed between the box (B) and the internal wall so as to create a space (E) between the box (B) and the internal wall (100).

2. A device (D) according to claim 1, characterized by the fact that it comprises at least one projection (210, 220) constituting the bracing element, one end of which is fixed to the internal wall (100) and projecting towards the inside of the tire (P), the box (B) being fixed to the projection (210, 220) at a certain distance from the internal wall so that a space (E) is created between the box (B) and the internal wall where the projection (210, 220) arises.

3. A device (D) according to claim 2, characterized by the fact that the projection (210, 220) is preformed from a support (211, 221) and holding (212, 222) surface for the box (B), disposed at a certain distance from the internal wall so that a space is created between the box (B) and the internal wall where the projection (210, 220) arises.

4. A device (D) according to claim 2, characterized by the fact that the projection (210, 220) arises from the internal face (100) of the tire tread.

5. A device (D) according to claim 2, characterized by the fact that it comprises two projections (210, 220).

6. A device (D) according to claim 2, characterized by the fact that the projection (210, 220) is preformed from a change in cross section in order to create a support surface (211, 221) for the box (B).

7. A device (D) according to claim 2, characterized by the fact that the projection (210, 220) comprises two changes in cross section creating two shoulders between which the box (B) is arranged so as to serve firstly as a support surface (211, 221) and secondly as a holding surface (212, 222).

8. A device (D) according to claim 2, characterized by the fact that the projection (210, 220) is produced from an elastic material.

9. A device (D) according to claim 2, characterized by the fact that the projection (210, 220) is produced from an elastic material and is preformed so that traction on its free end narrows the holding surface (212, 222) in order to enable the box (B) to be installed.

10. A device (D) according to claim 2, characterized by the fact that the projection (210, 220) is adhesively bonded to the internal wall.

11. A device (D) according to claim 2, characterized by the fact that the projection (210′, 220′) is associated with the top face of a flat piece (400) the internal face of which is adhesively bonded to the internal wall.

12. A device according to claim 1, characterized by the fact that the box is preformed from at least one projection constituting the bracing element coming to be fixed to the internal wall of the tire while creating a space between the box and the internal wall.

13. A device (D) according to claim 1, where the box (B) comprises a pressure sensor (313), characterized by the fact that the box (B) is oriented so that the measurement orifice (316) giving access to the sensor is open between the box (B) and the internal face (100) of the tread of the tire (P).

14. A device (D) according to claim 13, characterized by the fact that the sensor (313) is equipped with a cap (317) preventing the obstruction of its measurement orifice (316) when the encapsulating material (315) is poured into the box (B).

15. A method for manufacturing a tire (P), the tire comprising at least one projection (210, 220) constituting a bracing element, one end of which is fixed to the internal wall (100) of the tire (P) and projects towards the inside of the tire (P), a measurement box (B) being fixed to the projection (210, 220) at a certain distance from the internal wall so that a space (E) is created between the box (B) and the internal wall from which the projection (210, 220) arises, characterized in that it consists of moulding the at least one projection (110, 120) constituting the bracing element, in the internal wall of the tire (P).
